(19) United States
(12) Patent Application Publication
(10) Pub. No.: US 2016/0321347 A1
(43) Pub. Date: Nov. 3, 2016

(54) METHOD AND SYSTEM FOR COLLECTING INFORMATION BASED ON A SPECIFIC TOPIC

(71) Applicant: Alibaba Group Holding Limited, George Town (KY)

(72) Inventors: Minghan Zhou, Hangzhou (CN); Xuyuan Xiang, Hangzhou (CN); Xiao Wang, Hangzhou (CN)

(73) Assignee: Alibaba Group Holding Limited, George Town (KY)

(21) Appl. No.: 15/141,563

(22) Filed: Apr. 28, 2016

(30) Foreign Application Priority Data
Apr. 30, 2015 (CN) 201510219903.3

(51) Int. Cl. G06F 17/30

(52) U.S. Cl. CPC G06F 17/30598; G06F 17/30477; G06F 17/30424; G06F 17/30345

(57) ABSTRACT

Embodiments of the present application provide a method and system to collect information for a specific topic. During operation, the system may receive a dialog request sent by a client. The system may then determine a specific topic corresponding to the dialog request based on keywords included in the dialog request. The system may send questions formulated in a dialog framework to the client one by one according to the dialog framework preset for the specific topic. The system may receive a reply provided by the client to at least one question. The system may then create a record corresponding at least one of the questions and key information in the reply to generate an information collection package for the specific topic.

### RELATED APPLICATION

Under 35 U.S.C. 119, this application claims the benefits and rights of priority of Chinese Patent Application No. 201510219903.3, filed 30 Apr. 2015.

### BACKGROUND

1. Field

The present invention relates to information processing, and particularly relates to a method and system for collecting information based on a specific topic and a method of inquiry based on instant communication.

2. Related Art

In the traditional information collection field, the information collection process is usually performed orally or in writing. With the development of the Internet, there has been widespread adoption of Internet-based information collection approaches. For example, one may apply an Internet-based information collection approach to activities such as trading goods, public surveys, matchmaking, and social networking. Compared with traditional oral or written information collection approaches, the Internet-based information collection approach is efficient and convenient.

Currently, the commonly used Internet-based information collection approaches mainly include a template filling approach and an online instant communication approach.

With the template filling approach, an information receiving party provides an information collection template preset for a specific topic to an information provider. The information receiving party can be a seller such as a merchant. The merchant needs to obtain information such as product requirements from a potential buyer regarding the products that the buyer is interested in, and therefore is called the information receiving party. The information provider can be a potential buyer inquiring about some products that the merchant is selling. The potential buyer may provide information regarding product requirements to the merchant. In some scenarios, the information receiving party can be a potential buyer, and the information provider can be a potential seller seeking to interest the potential buyer in a purchase transaction.

After the information provider fills in the information collection template, an e-commerce platform may generate an information collection package based on the information filled in by the information provider. For example, the information receiving party may preset a survey form template containing survey questions, and the information receiving party may receive useful information based on the submitted survey form after the information provider fills and submits the survey form template.

With the online instant communication approach, the information provider participates in a real-time online dialog with the information receiving party for a specific topic using an online instant communication tool to allow the information receiving party to obtain useful information from the dialog. For example, the Alibaba Trade Manager (ATM) online instant communication tool international edition from the Alibaba website allows a inquiring party interested in a particular product to inquire of the product in real-time with the product supplier.

In practical application, the information receiving party may make the template filling approach and/or online instant communication approach available to the information provider, so as to allow the information provider to provide the information receiving party with useful information. When the information receiving party makes both of the above two approaches available to the information provider, the information provider may provide information to the information receiving party based on any one of the two approaches according to specific circumstances, so as to allow the information receiving party to collect useful information.

The above two Internet-based information collection methods have their respective advantages and disadvantages, which are described below.

With the template filling approach, the advantages of this approach includes that there is no time difference issue, so that the information provider may fill the information collection template at any time. This allows the information providing party to provide useful information to the information receiving party. There is a level of difficulty in filling out the information collection template, since the template may include abundant content and a complex format. However, because the information collection template may include much content and a complex format, there may be a problem of difficulty in filling the information collection template. There are higher requirements for the information provider in terms of template filling capability, and only an information provider with a high-level template filling capability can complete a high-quality information collection template. However, information providers with a low level of template filling capability are not good at or lack patience in filling in a detailed and complex information collection template, and the filled-in information collection template may be characterized by a low degree of completeness or professionalism. This may result in difficulties in information collection for the information receiving party. Clearly, this approach is not applicable to information providers with a low level of template filling capability. However, according to existing website statistics, there are a large number of information providers with a low level of template filling capability. It is thus clear that this approach is only useful to a minority of information providers.

With the online instant communication approach, the advantages of this approach lie in that the information provider may communicate in real-time with the information receiving party, and there is almost no requirement on the part of the information provider. However, because the information receiving party and the information provider are required to be online simultaneously for this approach to work, the information provider may communicate in real-time with the information receiving party using an online instant communication tool only when the information receiving party is online. When the information receiving party is offline, the information provider may use the online instant communication tool to send a message. The information receiving party cannot provide a prompt reply, and the information provider cannot conduct instant communications with the information receiving party. The result is that the information receiving party cannot collect information from the information provider. Clearly, this approach is not suitable when there is a relatively large time difference between the information provider and the information receiving party.

In conclusion, for Internet-based information collection, the above template filling approach and online instant communication approach cannot satisfy practical application requirements. The template filling approach is not suitable for information providers with a low level of template filling capability, and it is generally impossible to have control over the template filling capability of the information provider in practical application. When using the online instant communication approach to collect information for a specific topic, if the information receiving party is offline, it is impossible for the information provider using current technology to participate in a real-time information collection service for the specific topic.

### SUMMARY

One embodiment of the present invention provides a system for collecting information for a specific topic. During operation, the system may receive a dialog request sent by a client. The system may determine a specific topic corresponding to the dialog request based on keywords included in the dialog request. The system may then send questions formulated in a dialog framework to the client one by one according to the dialog framework preset for the specific topic. The system may receive a reply provided by the client to at least one question. The system may subsequently create a record corresponding at least one of the questions and key information in the reply to generate an information collection package for the specific topic.

In a variation of this embodiment, key information in the reply to the question includes keywords of the reply corresponding to predefined key fields of the question.

In a variation of this embodiment, the system may determine key fields predefined for a question based on a corresponding relationship between the question and key fields. The system may then parse the reply to the question, and extract keywords corresponding to the key fields from the reply based on the key fields predefined for the question as key information for the reply to the question.

In a variation on this embodiment, the information collection package includes a preset information collection report template.

In a further variation, the system may create a record corresponding at least one of the questions and key information in the reply to the question to generate an information collection package for the specific topic, which involves using the key information of the reply to the question to populate a preset location of an information collection report template.

In a variation on this embodiment, sending questions formulated in a dialog framework to the client one by one according to the dialog framework preset for the specific topic and receiving a reply provided by the client to at least one question further includes reading a question formulated in the dialog framework in traversal mode. The system may present the question to the client. The system may then receive a reply provided by the client to the question. The system may determine whether there is any question that has not been presented to the client. In response to determining that there is a question that has not been presented to the client, the system may read a next question formulated in the dialog framework to present the next question to the client.

In a variation of this embodiment, sending questions formulated in a dialog framework to the client one by one according to the dialog framework preset for the specific topic and receiving a reply provided by the client to at least one question further includes presenting a current question preset in the dialog framework to the client. The system may then receive a reply provided by the client to the current question, and obtain and present a next question to the client based on the reply received for the current question and the dialog framework. The system may receive a reply provided by the client for the next question.

In a variation on this embodiment, the questions pre-formulated for the dialog framework are customizable.

In a variation on this embodiment, the system may generate questions formulated in the dialog framework based on a historical dialog record relevant to the specific topic.

In a further variation, generating the questions formulated in the dialog framework further includes obtaining a historical dialog record relevant to the specific topic. The system may also extract required elements for constructing the dialog framework from the historical dialog record with machine learning, and generate the questions formulated in the dialog framework based on required elements for constructing the dialog framework.

In a variation on this embodiment, the system may generate the questions formulated in the dialog framework based on one or more original dialog frameworks preset for the specific topic.

In a variation on this embodiment, the system may generate the questions formulated in the dialog framework by performing operations that include obtaining multiple original dialog frameworks. The system may also extract common questions from among the multiple original dialog frameworks, and use the common questions as the questions formulated in the dialog framework for the specific topic.

In a variation on this embodiment, the questions formulated in the dialog framework are generated based on the information collection question template preset for the specific topic.

In a further variation, the questions formulated in the dialog framework are generated by performing operations that include parsing the preset information collection question template. The system may also obtain the questions included in the information collection question template, and use the questions in the information collection question template as the questions formulated in the dialog framework.

In a variation on this embodiment, the system may send the information collection package to an information receiving party associated with the specific topic.

Another embodiment of the present invention provides a system for instant communication-based inquiry between a first client and a second client exchanging information on an e-commerce platform. During operation, the system may receive an inquiry request made by a first client on a webpage associated with a second client. The inquiry request may indicate at least one of a first inquiry mode and a second inquiry mode. Under the first inquiry mode, a user associated with the second client conducts instant communication with a user associated with the first client, and under the second inquiry mode, a user associated with the second client is not directly conducting instant communication with the user associated with the first client. The system may send questions formulated based on a preset dialog framework to the first client according to the dialog framework preset for a specific topic when the inquiry request is under the second inquiry mode. The system may then receive a reply provided by the first client for at least one question, and generate an inquiry form based on at least the reply.

In a variation on this embodiment, the e-commerce platform is configured to prioritize sending the inquiry form to the user associated with the second client within a first time period after generating the inquiry form.

In a variation on this embodiment, the e-commerce platform is configured to prioritize sending the inquiry form to users of other clients associated with the topic of the inquiry form after a first time period after the inquiry form is generated.

### BRIEF DESCRIPTION OF THE DRAWINGS

The accompanying drawings described herein are used for further understanding the present application and constitute a part of the present application, and the schematic embodiments of the present application and the descriptions thereof are used for interpreting the present application, rather than improperly limiting the present application. In which:

FIG. 1 presents a diagram illustrating an exemplary computing system for collecting information based on a specific topic, in accordance with an embodiment of the present invention.

FIG. 2 presents a flowchart illustrating an exemplary process for collecting information based on a specific topic, in accordance with an embodiment of the present invention.

FIG. 3 presents a flowchart illustrating another exemplary process for collecting information based on a specific topic, in accordance with an embodiment of the present invention.

FIG. 4 presents a flowchart illustrating sub-operations for generating questions based on a historical dialog record relevant to a specific topic, in accordance with an embodiment of the present invention.

FIG. 5 presents a flowchart illustrating sub-operations for generating questions based on an original dialog framework preset for a specific topic, in accordance with an embodiment of the present invention.

FIG. 6 presents a flowchart illustrating sub-operations for generating questions based on an information collection question template preset for a specific topic, in accordance with an embodiment of the present invention.

FIG. 7 presents a flowchart illustrating sub-operations for presenting questions using a process in which the system does not consider the content of previous replies, in accordance with an embodiment of the present invention.

FIG. 8 presents a flowchart illustrating sub-operations for presenting questions so that the next question is related to the content of a reply to a previously presented question, in accordance with an embodiment of the present invention.

FIG. 9 presents a flowchart illustrating sub-operations to correspond at least one question and key information from a reply, in accordance with an embodiment of the present invention.

FIG. 10 presents a flowchart illustrating sub-operations to populate preset locations of an information collection report template, in accordance with an embodiment of the present invention.

FIG. 11 is a schematic diagram illustrating an exemplary apparatus for collecting information based on a specific topic, in accordance with an embodiment of the present invention.

FIG. 12 is a schematic diagram illustrating an exemplary question answering module, in accordance with an embodiment of the present invention.

FIG. 13 is a schematic diagram illustrating another exemplary question answering module, in accordance with an embodiment of the present invention.

FIG. 14 is a schematic diagram illustrating an exemplary information collection apparatus for a specific topic, in accordance with an embodiment of the present invention.

FIG. 15 presents a block diagram illustrating an exemplary electronic equipment, in accordance with an embodiment of the present application.

FIG. 16 presents a flowchart illustrating an exemplary process for instant messaging-based inquiry, in accordance with an embodiment of the present invention.

FIG. 17 is a diagram illustrating an exemplary webpage associated with a second client for an instant messaging-based inquiry method under a first inquiry mode, in accordance with an embodiment of the present invention.

FIG. 18 is a diagram illustrating an exemplary webpage associated with a second client for an instant messaging-based inquiry method under a second inquiry mode, in accordance with an embodiment of the present invention.

FIG. 19 is a diagram illustrating an exemplary question page of an instant messaging-based inquiry method for a first client under a second inquiry mode, in accordance with an embodiment of the present invention.

FIG. 20 is a diagram illustrating an exemplary inquiry form generated using an instant messaging-based inquiry method, in accordance with an embodiment of the present invention.

FIG. 21 presents a block diagram illustrating an exemplary instant messaging-based inquiry apparatus, in accordance with an embodiment of the present invention.

FIG. 22 presents a block diagram illustrating an exemplary server in a system for information collection based on a specific topic, in accordance with an embodiment of the present application.

### DETAILED DESCRIPTION OF EMBODIMENTS

Embodiments of the present invention solve the problems of difficult to fill inquiry templates and trading partners being offline and unavailable by collecting inquiry information from a client device in real-time using a question and answer process, which is easier and more effective than sending a blank template to a user to fill in. A system for collecting information may also use a robot assistant to automatically collect information from a user in real-time through an instant messaging communication service when a party that is to receive the information, such as a merchant, is offline.

When a client device associated with a potential buyer requests to initiate a dialogue based on a specific topic, the system may determine the specific topic of the dialogue and provide a real-time dialog service based on the specific topic to the client. The system may provide the dialog service to the client using a question and answer technique in accordance with a dialog framework preset for the specific topic. The system may generate an information collection package for the specific topic based on the contents of the dialog, and send the information collection package to an information receiving party such as a user or a merchant. This allows the system to provide the real-time dialog service with respect to the specific topic to the client to improve the information collection success rate even if the information receiving party is offline.

### Exemplary Computing System for Collecting Information Based on Specific Topic

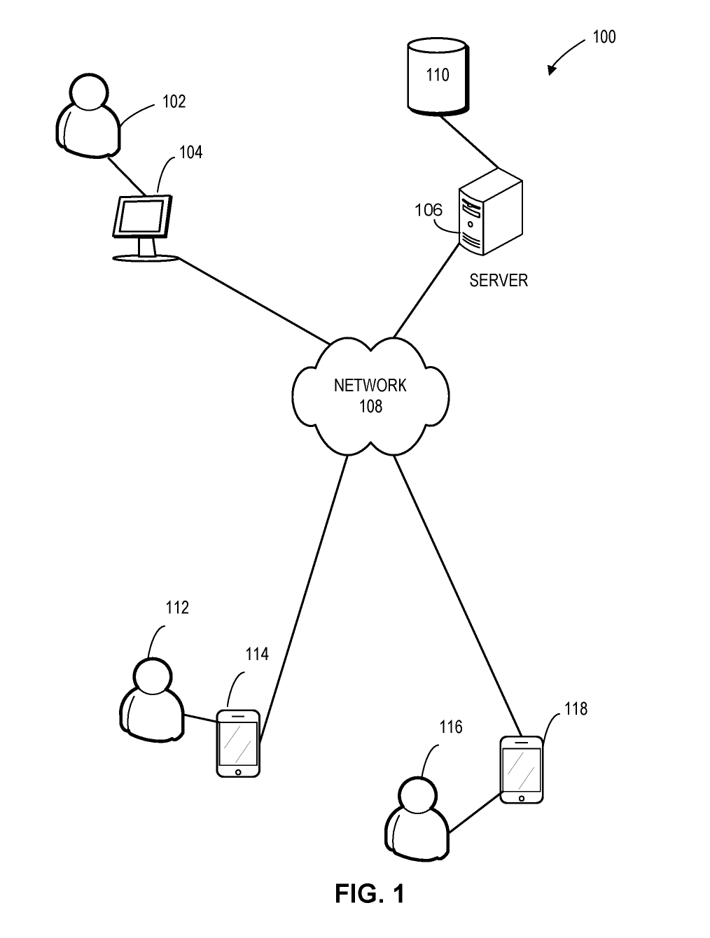

FIG. 1 presents a diagram illustrating an exemplary computing system 100 for collecting information based on a specific topic, in accordance with an embodiment of the present invention. As illustrated in FIG. 1, a user 102 may be operating a computing device 104 with installed modules that allows user 102 to participate in instant messaging, view Internet webpages, and receive e-mails and inquiries. User 102 may also operate computing device 104 to edit templates and questions for collecting information from other parties inquiring about products. Computing device 104 may be a mobile device such as a mobile phone, a tablet, or a laptop, a desktop computer, or any other type of computing device. User 102 may represent, for example, a merchant with products to sell. Computing device 104 may communicate with a server 106 over a network 108. Server 106 may represent an e-commerce server that allows buyers to view products available for sale from sellers and conduct business transactions to purchase the products. Server 106 may include a storage 110 for storing code for various applications and other data, such as code for e-commerce server software, product data, and customer and merchant data. Storage 110 may also store code for the modules described herein, such as a request receiving module which receives a dialogue request from a client or an information package generating module which generates an information collection package for a specific topic. Note that server 106 may represent a cluster of machines supporting functions of the e-commerce server.

User 112 may operate a client 114, and user 116 may operate a client 118. For example, user 112 may operate client 114 to connect to server 106 and view products for sale from user 102 on server 106. User 112 can use client 114 to interact with server 106 and respond to questions while making an inquiry regarding buying or selling a product. User 112 can also use client 114 to conduct instant messaging with other parties, such as user 102. Note that each of clients 114, 116 may be a mobile device such as a mobile phone, a tablet, or a laptop, a desktop computer, or any other type of computing device.

In some embodiments, a client can send a request for customized executable code that when installed allows for instant messaging and/or interacting with server 106. The client can receive the executable code from server 106 and then install the executable code to enable instant messaging and other user interaction with server 106. Further, server 106 can automatically update the executable code.

In some embodiments, server 106 can provide a uniform interface with a consistent “look and feel” to present products for sale from different merchants. Server 106 can present product-related content information from the different merchants. When the user clicks on a link to view a product's item description or to make an inquiry regarding a product, the system can retrieve information for the product and preset templates and generate a webpage to display information for the product or interact with the user in a question and answer session to collect inquiry information from the user. Through a uniform and consistent interface, server 106 can use a question and answer technique to collect information from different users for different merchants. Server 106 can also provide a uniform interface for merchants to interact with potential buyers and receive inquiries from users, such as inquiries regarding products available to merchants. With the uniform interfaces provided by server 106, users need not visit individual merchant websites since they can perform all aspects of a business transaction within the context of the website, and users benefit from an easy to comprehend website with a uniform and integrated look and feel.

In some embodiments, server 106 can also directly pull product information from merchant websites or databases and use the product information when generating questions for use in a question and answer technique to determine a user's product requirements and other product inquiry-related information. This allows the system to present a consistent and uniform interface to users when collecting information from users for multiple different merchants. Server 106 can also use the pulled information with instant messaging to communicate with users on behalf of different merchants.

Note that the techniques discussed in the present disclosure represent an improvement in various technology areas such as human-machine interaction, machine learning, data mining, and communications.

### Exemplary Process for Collecting Information Based on a Specific Topic

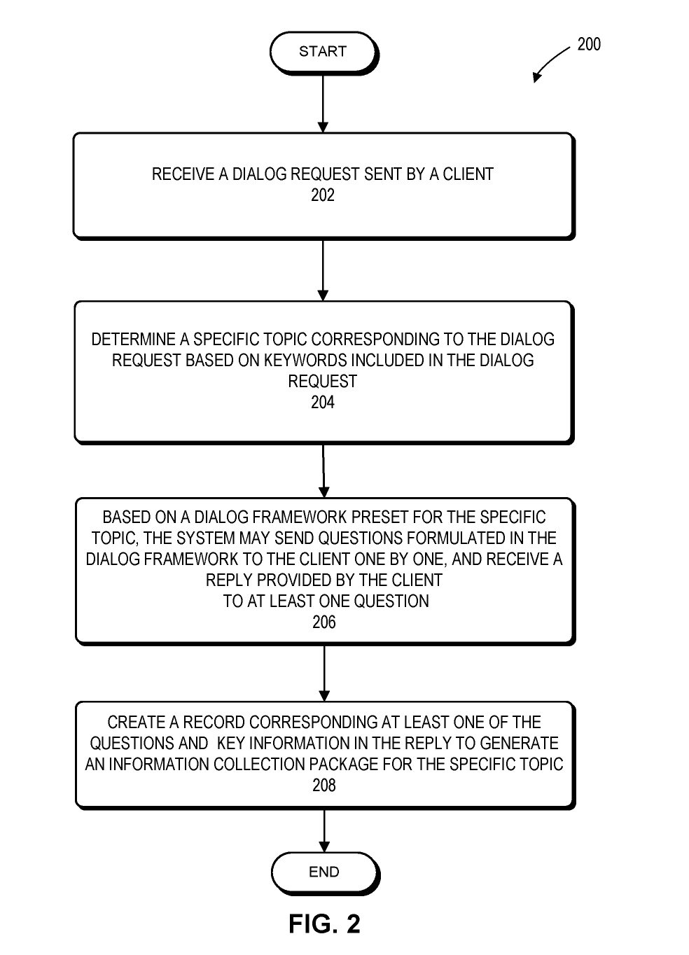

FIG. 2 presents a flowchart 200 illustrating an exemplary process for collecting information based on a specific topic, in accordance with an embodiment of the present invention. During operation, the system may receive a dialog request sent by a client (operation 202). The client can be a computing device operated by a potential buyer or seller, but is usually a buyer. The system may determine a specific topic corresponding to the dialog request based on keywords included in the dialog request (operation 204). Based on a dialog framework preset for the specific topic, the system may send questions formulated in the dialog framework to the client one by one, and receive a reply provided by the client to at least one question (operation 206). The system may create a record corresponding at least one of the questions and key information in the reply to generate an information collection package for the specific topic (operation 208). These operations are described in further detail below.

During operation, the system may receive a dialog request sent by a client (operation 202). The specific topic may include various different types of topics for information collection. Using “an inquiry for a specified product” as a specific topic example, an application scenario in which a client makes an inquiry for a specified product using the Internet is “performing information collection based on the inquiry for the specified product.” In this case, the specific topic corresponding to the application scenario is “an inquiry for a specified product” when the system applies the method described in the present disclosure in the application scenario. The system can use the disclosed information collection based on a specific topic technique in the context of collecting various types of information for a specific topic, such as when trading goods, social surveying, match making, and social networking.

The client may be mobile communication equipment such as a mobile device or a smart phone and may also be terminal equipment such as a personal computer, PAD, or iPad. A user of the client is one of the application users of the method disclosed herein, and is called the information providing party.

An inquiry for a specified product using the Internet is a typical application scenario for information collection based on a specific topic. An inquiry, also called a consultation, is a business activity in which a trading partner, who intends to buy or sell a product, seeks information on a product, trade terms, or the possibility of trade from potential suppliers or buyers. An inquiry lacks legally binding force since the inquiry is only seeking information on the possibility of buying or selling. The buyer generally sends the inquiry to the seller in actual business practice. An inquiry is not necessary for each trade transaction. If both parties to the trade are familiar with each other and the terms of the business transaction, the parties do not need to seek information on trade terms or the possibility of trade from each other, and can directly send an offer to the other party to form a commercial order without the need for an inquiry.

In traditional trade negotiations, the inquiries are typically made orally or in writing. The inquiry, without legally binding force, can be taken as tentative negotiations with the inquiry receiving party. An inquiring party can send inquiries to multiple inquiry receiving parties simultaneously. Among the multiple inquiry receiving parties receiving inquiries, an inquiry receiving party needs to reply to an inquiry promptly and effectively, if the inquiry receiving party wants to make a successful trade. Due to the fact that inquiries are usually made between the buyers and the sellers at home and abroad, the traditional inquiries in oral or written form are not good for receiving a timely and effective reply to an inquiry from inquiry receiving parties. This may cause inquiry receiving parties to lose trading opportunities.

With the development of the Internet, an Internet-based inquiry processing method has been extensively applied. For example, the Internet-based inquiry processing method has been the most important channel for trade communication between buyers and sellers at alibaba.com, and both parties benefit from an efficient and convenient inquiry service method. In general, the contents of an inquiry may relate to aspects such as price, specification, quality, quantity, packaging, shipment, and a request for samples. Currently, two common Internet-based inquiry processing methods include: 1) the inquiring party sends an inquiry letter regarding a product to an inquiry receiving party using an inquiry template preset by the inquiry receiving party; and 2) the inquiring party sends a real-time online inquiry to the inquiry receiving party using an online instant communication tool. The two inquiry processing methods each have some respective limitations. The inquiry letter method is limited in that the inquiring party needs to fill out a relatively complex inquiry template requiring much information. The online instant communication method is limited in that the inquiry receiving party must be online in order to communicate with the inquiring party using the online instant communication tool.

One can categorize an inquiring party into an amateur inquiring party or a professional inquiring party based on their familiarity with inquiries. The professional inquiring party is well-versed in the inquiry letter method and the online instant communication method, and can send out inquiry letters with higher quality and greater detail. In contrast, the amateur inquiring party is not adept at filling in a detailed and complex inquiry template. After sending communication messages using the online communication tool, the amateur inquiring party's patience may run out if the inquiry receiving party cannot reply promptly due to time differences. Also, even if the amateur inquiring party sends an inquiry to the inquiry receiving party using the inquiry letter method, the inquiry receiving party may neglect low quality inquiries that are insufficiently complete or that are not filled in professionally. It is apparent that the inquiry processing methods described above cannot satisfy the needs of amateur inquiring parties. According to existing website data, there are a very large number of amateur inquiring parties and existing Internet-based inquiry processing methods cannot completely meet the amateur inquiring party's needs. With the online instant communication inquiry processing method, current technology cannot provide a real-time inquiry service to the inquiring party when the inquiry receiving party is offline.

In summary, an inquiry for a specified product using the Internet is a typical application scenario for information collection based on a specific topic. Using the application scenario in which the inquiring party (that is the information provider) makes an inquiry for the specified product as an example, this disclosure describes the operations of a method that the system applies to facilitate the exchange of trade information between the potential buyer and seller. When the system applies the method to the inquiry for the specified product, the inquiring party first needs to send an inquiry dialog request for the specified product to a server (e.g., an inquiry service platform) via the client of the inquiring party.

The system may determine the specific topic corresponding to the dialog request based on keywords included in the dialog request (operation 204).

The dialog request may include keywords that the system may use to determine the specific topic. After the system receives the dialog request sent by the client, the system can determine the corresponding specific topic of the dialog request sent by the client in accordance with keywords in the dialog request and the corresponding relationships between preset keywords and specific topics.

In some embodiments, the keywords included in the dialog request sent by the inquiring party may include the service code of the inquiry topic and an identifier code for the product that is the subject of the inquiry. The system may parse the keywords in the dialog request and make an inquiry for the specified product corresponding to the code to determine the specific topic. After the system determines the specific topic of the dialog request, the system can continue to perform the next operation of sending questions to the client.

The system may send the questions formulated in the dialog framework one by one to the client based on a dialog framework preset for the specific topic, and receive a reply provided by the client to at least one question (operation 206).

The dialog framework corresponds to a specific topic. The system may preset various dialog questions relevant to the specific topic of the dialog framework. To make the questions in the dialog framework meet actual requirements, the questions formulated in the dialog framework are customizable. That is, based on preset standards, a human user, such as the information receiving party, can customize the questions in the dialog framework using manual intervention after the system automatically generates the questions for the specific topic in the dialog framework.

### Another Exemplary Process for Collecting Information

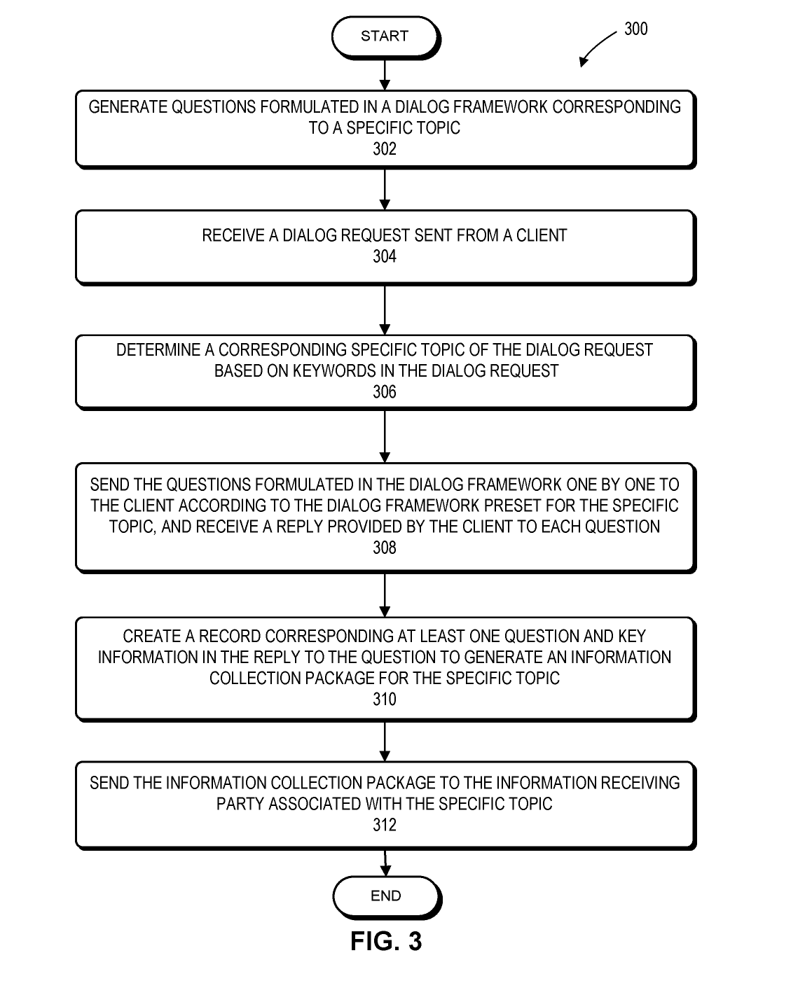

FIG. 3 presents a flowchart 300 illustrating another exemplary process for collecting information based on a specific topic, in accordance with an embodiment of the present invention. FIG. 3 is similar to FIG. 2 with the additional operations 302 and 312. During operation, the system may generate questions formulated in a dialog framework corresponding to a specific topic (operation 302). The system may then receive a dialog request sent from a client (operation 304). The system may determine a corresponding specific topic of the dialog request based on keywords in the dialog request (operation 306). The system may then send the questions formulated in the dialog framework one by one to the client according to the dialog framework preset for the specific topic, and receive a reply provided by the client to each question (operation 308). The system may subsequently create a record corresponding at least one question and key information in the reply to the question to generate an information collection package for the specific topic (operation 310). The system may send the information collection package to the information receiving party associated with the specific topic (operation 312). Operations 302 and 312 are described in greater detail below. Note that operations 304-310 are analogous to the operations of FIG. 2 and are not discussed separately in detail.

In some implementations, the system may initially need to set questions included in the dialog framework for the specific topic if the system sends the questions formulated in the dialog framework to the client one by one. In some embodiments, before performing operation 202 of FIG. 2 (e.g., operation 304 of FIG. 3), the system may further perform operation 302 below.

The system may generate questions formulated in a dialog framework corresponding to a specific topic (operation 302). In some implementations, the system may generate the questions formulated in the dialog framework for the specific topic in accordance with specific application requirements and various preset standards. Below is a description of three different techniques for generating questions formulated in the dialog framework for the specific topic. These techniques include generating questions based on a historical dialogue record, generating questions based on an original dialog framework, and generating questions based on an information collection question template.

### Technique Number 1—Generate Questions Based on Historical Dialog Record

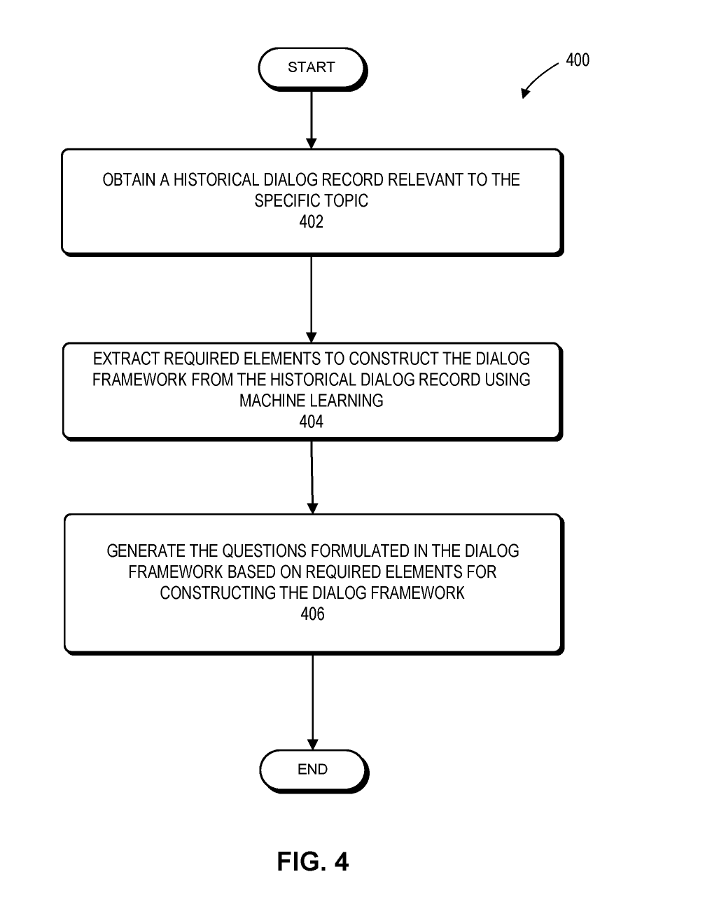

FIG. 4 presents a flowchart 400 illustrating sub-operations of operation 302 for generating questions based on a historical dialog record relevant to a specific topic, in accordance with an embodiment of the present invention. The system may generate questions formulated in the dialog framework based on a historical dialog record relevant to the specific topic. The historical dialog record relevant to the specific topic may include various common questions relevant to the specific topic, and those questions are universally applicable. For this reason, it is a reasonable and feasible in an embodiment to generate questions formulated in the dialog framework corresponding to the specific topic by extracting common questions from the historical dialog record.

In some embodiments, using technique number 1 to generate the questions formulated in the dialog framework may include multiple operations as follows: 1) obtaining a historical dialog record relevant to the specific topic (operation 402); 2) extracting required elements to construct the dialog framework from the historical dialog record using machine learning (operation 404); and 3) generating the questions formulated in the dialog framework based on required elements for constructing the dialog framework (operation 406).

1) The System May Obtain a Historical Dialog Record Relevant to the Specific Topic (Operation 402).

In order to generate the questions formulated in the dialog framework based on the historical dialog record relevant to the specific topic, the system first obtains the historical dialog record relevant to the specific topic. The system may accumulate and store the historical dialog record relevant to the specific topic in real time by collecting information from each dialog with respect to the specific topic. In some implementations the system can store the historical dialog record corresponding to the specific topic in different storage formats based on specific application requirements. For example, the formats may include text format and database format.

2) The System May Extract Required Elements to Construct the Dialog Framework from the Historical Dialog Framework Using Machine Learning (Operation 404).

The historical dialog record relevant to the specific topic may include each original dialog record from collecting information with respect to a specific topic. The original dialog record generated from actual dialog may include other information not relevant to the specific topic, various redundant information, and nonstandard dialog information such as spoken language. Therefore, the system may remove the useless information first from the historical dialog record, and then extract various useful information using machine learning. The required elements for constructing the dialog framework include various types of useful information extracted from the historical dialog record. The system may generate the questions formulated in the dialog framework by extracting the useful information.

Machine learning, as an intersection of subjects involving many fields, refers to Probability Theory, Statistics, Theory of Approximation, Convex Analysis, Algorithm Complexity, etc. With machine learning one can use the computer to simulate or realize the learning behavior of humans, so as to obtain new knowledge or skills, and reconstruct the knowledge structure to continuously improve performance. In some embodiments, the system can extract the required elements for constructing the dialog framework from the historical dialog record using machine learning.

3) The System May Generate the Questions Formulated in the Dialog Framework Based on the Required Elements for Constructing the Dialog Framework (Operation 406).

In some embodiments, the system may use machine learning to continuously optimize and perfect the applicability of the questions formulated in the dialog framework to the specific topic by accumulating and learning from big data in continuously accumulated historical dialog records.

### Technique Number 2—Generate Questions Based on Original Dialog Framework

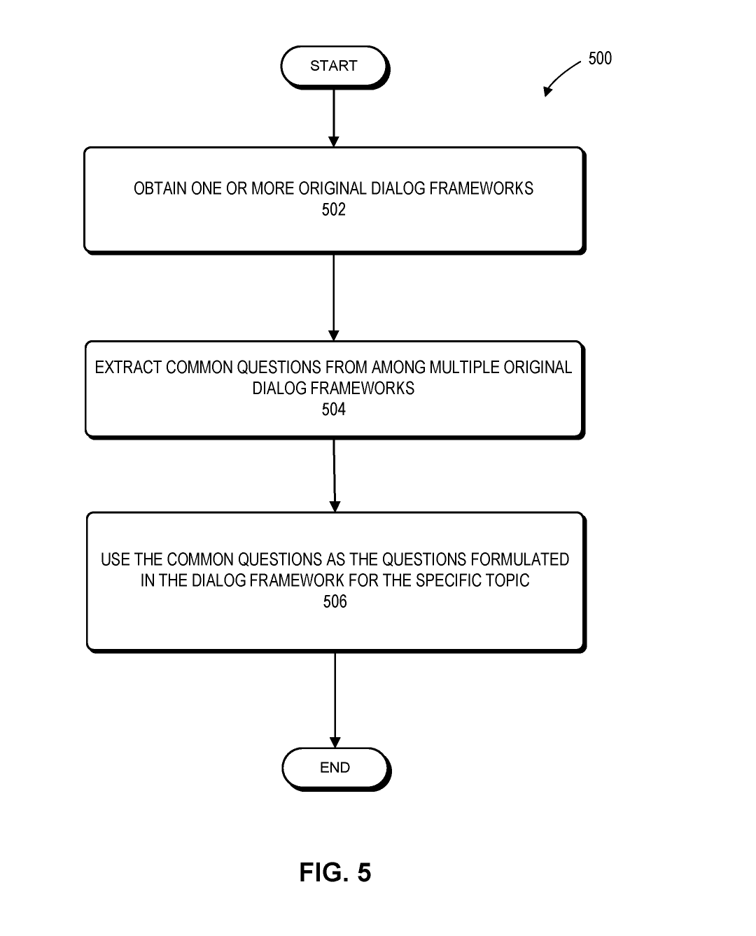

FIG. 5 presents a flowchart 500 illustrating sub-operations of operation 302 for generating questions based on an original dialog framework preset for a specific topic, in accordance with an embodiment of the present invention. The system may generate the questions formulated in the dialog framework based on the original dialog framework preset for the specific topic. The original dialog framework refers to a dialog framework in an earlier base version of the dialog framework preset for the specific topic. With technique number 2, the system may form the dialog framework preset for the specific topic based on the original dialog framework. There is no limit to the quantity of the original dialog frameworks corresponding to the specific topic. That is, one specific topic may correspond to one or more original dialog frameworks.

In some embodiments, multiple original dialog frameworks may correspond to the specific topic “inquiry for a specified product.” For example, different suppliers selling the same specified product may each respectively set the questions formulated in dialog frameworks for the specified product. The dialog frameworks are called the original dialog frameworks of the “inquiry for a specified product.” At a later time, a supplier can obtain (e.g., generate) a more appropriate dialog framework by referencing one or more original dialog frameworks when the supplier sets the questions formulated in the dialog framework for the specified product.

Generating the questions formulated in the dialog framework by using one or more original dialog frameworks preset for the specific topic involves a certain theoretical basis. This theoretical basis is as follows: with a better understanding of the specific topic, the dialog framework that the system sets for the specific topic at an earlier stage might not be applicable to current conditions. Thus, the system may need to reset the questions included in the dialog framework for the specific topic based on the dialog framework set for the specific topic at the earlier stage. Because the system using technique number 2 generates a new and more applicable dialog framework based on the original dialog framework, it is appropriate in some embodiments to set the questions in the dialog framework for the specific topic by using technique number 2.

In some embodiments, using technique number 2 to generate questions formulated in the dialog framework for the specific topic may include multiple operations. These operations may include 1) obtain one or more original dialog frameworks (operation 502); 2) extract common questions from among multiple original dialog frameworks (operation 504); and 3) use the common questions as the questions formulated in the dialog framework for the specific topic (operation 506).

1) The System May Obtain One or More Original Dialog Frameworks (Operation 502).

To generate questions formulated in the dialog framework based on original dialog frameworks preset for the specific topic, the system may first need to obtain one or more original dialog frameworks for the specific topic. In some implementations, the system can first store the corresponding original dialog frameworks of the specific topic in different storage formats (e.g., text format and/or database format) based on specific application requirements. 2) The system may extract common questions from among multiple original dialog frameworks (operation 504).

In some embodiments, when the specific topic corresponds to multiple original dialog frameworks, the system can extract common questions among the different original dialog frameworks from all the original dialog frameworks, and the system can thereby generate a more appropriate (e.g., more suitable) dialog framework of the specific topic. If there is only one original dialog framework, the system can extract questions from the original dialog framework.

3) The System May Use the Common Questions as the Questions Formulated in the Dialog Framework for the Specific Topic (Operation 506).

After the system obtains common questions from among multiple different original dialog frameworks, the system can directly use these common questions to generate the questions formulated in the dialog framework for the specific topic. The system can also generate the questions formulated in the dialog framework for the specific topic based on the common questions after manual intervention from the information receiving party associated with the specific topic. In some implementations, the system may select different methods to formulate questions in the dialog framework for the specific topic based on specific application requirements.

### Technique Number 3—Generate Questions Based on Information Collection Question Template

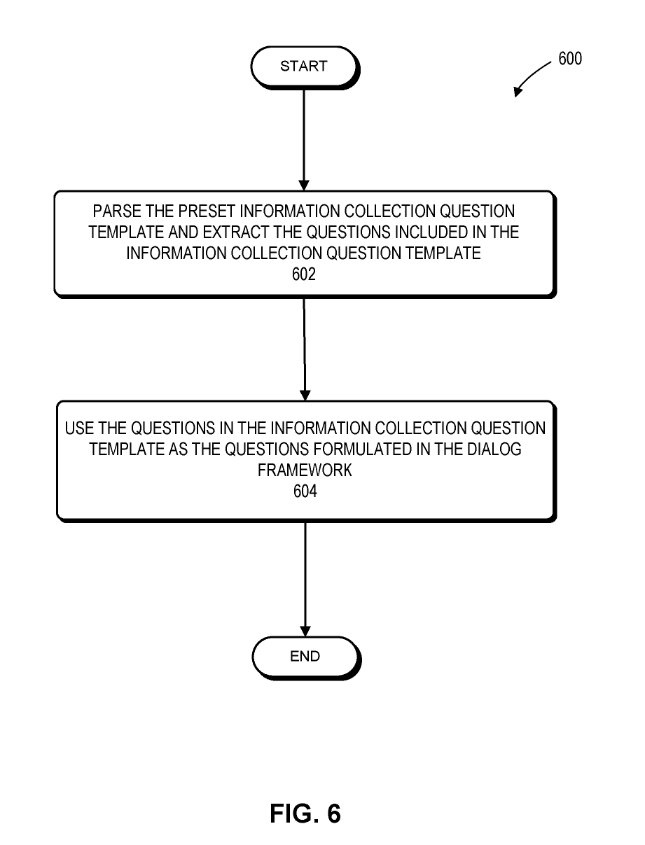

FIG. 6 presents a flowchart 600 illustrating sub-operations of operation 302 for generating questions based on an information collection question template preset for a specific topic, in accordance with an embodiment of the present invention. The system may generate questions formulated in the dialog framework based on an information collection question template preset for the specific topic.

The information collection question template refers to an information collection question template preset for a specific topic from the information receiving party associated with the specific topic. All questions corresponding to information that needs to be collected by the information receiving party associated with the specific topic are included in the information collection question template.

The technique of generating questions formulated in the dialog framework based on the information collection question template preset for the specific topic has a theoretical basis. The questions in the information collection question template may not all be clearly presented to the information provider. The template is complex and may not be easy to fill out for an information provider who is not familiar with the information collection question template. Since technique number 3 provides a dialog framework with an improved presentation based on parsing the information collection question template, it is appropriate and feasible to use technique number 3 in an embodiment to generate questions in the dialog framework for the specific topic.

In some embodiments, the system may use technique number 3 to generate questions formulated in the dialog framework for the specific topic. The operations of technique number 3 may include 1) parse the preset information collection question template and extract the questions included in the information collection question template (operation 602); and 2) use the questions in the information collection question template as the questions formulated in the dialog framework (operation 604). The details of these operations are discussed below.

1) The system may parse the preset information collection question template and extract the questions included in the information collection question template (operation 602).

To generate questions formulated in the dialog framework based on the information collection question template preset for the specific topic, the system must first parse the information collection question template. The system parses all explicit questions in information collection question templates that do not present questions clearly.

2) The system may use the questions included in the information collection question template as the questions formulated in the dialog framework (operation 604).

After the system extracts the explicit questions from the information collection question template, the system may use the explicit questions to generate the questions formulated in the dialog framework, thereby enabling the information provider to easily complete all the questions formulated in the dialog framework.

The above three methods represent only a portion of the specific embodiments that the system can use to formulate questions for the dialog framework. In some implementations, the system may use other methods to formulate questions in the dialog framework for the specific topic based on specific application requirements.

Presenting Questions without Considering Previous Replies

When the system has completed the dialog framework preset for the specific topic, the system may send questions formulated in the dialog framework one by one to the client. The system may receive a reply provided by the client to at least one question. In some implementations, based on specific application requirements, the system may use multiple questioning methods to send the questions formulated in the dialog framework one by one to the client, and the system may receive the reply provided by the client to at least one question.

Below lists two selectable specific embodiments of operation 206 from FIG. 2 in an embodiment. Based on the dialog framework preset for the specific topic, the system may send the questions formulated in the dialog framework to the client one by one, and receive the reply to at least one question provided by the client.

The basic idea of the first questioning method is that the system presents the questions formulated in the dialog framework one by one to the client. Each presented question is not related to the client's replies to preceding questions.

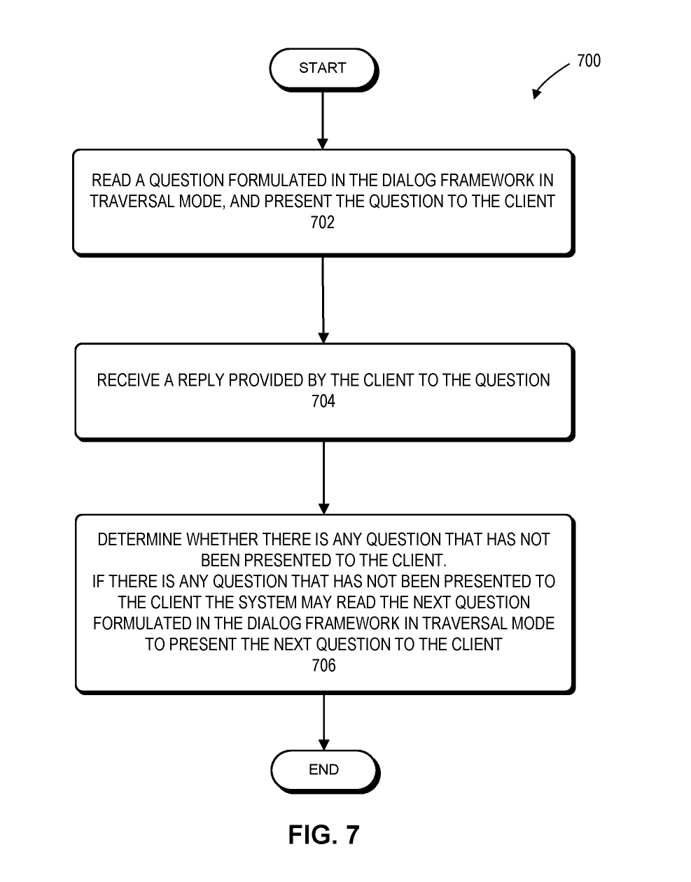

FIG. 7 presents a flowchart 700 illustrating sub-operations of operation 206 for presenting questions using a process in which the system does not consider the content of previous replies, in accordance with an embodiment of the present invention. In some embodiments, applying the first questioning method, sending the questions formulated in the dialog framework one by one to the client based on a dialog framework preset for the specific topic, and receiving from the client the reply to at least one question, may include the following operations:

The system may read a question formulated in the dialog framework in traversal mode, and present the question to the client (operation 702). The system may receive a reply provided by the client to the question (operation 704). The system may then determine whether there is any question that has not been presented to the client. If there is any question that has not been presented to the client, the system may read the next question formulated in the dialog framework in traversal mode to present the next question to the client (operation 706). The system may continue to present questions until all questions have been presented.

In some embodiments, at least one question is included in the dialog framework. As for the first questioning method, the system needs to traverse each question in the dialog framework until all the questions in the dialog framework are presented to the client. The system may generate the questions formulated in the dialog framework based on all the questions in the information collection question template preset for the specific topic. The questions formulated in the dialog framework may substantially include all the original subsets of questions obtained after parsing the information collection question template.

Presenting Questions while Considering Previous Replies

The basic idea of the second questioning method is that the system presents the questions formulated in the dialog framework to the client, and the currently presented question is related to the contents of a reply to a previously presented question, which is usually the preceding question. The difference between the first questioning method and the second questioning method is whether the next question is related to the content of the reply (or replies) to the previously presented question (or questions). When using the first questioning method, the system needs to present all the questions in the dialog framework one by one to the client. When using the second questioning method, the system might not need to present all the questions in the dialog framework to the client.

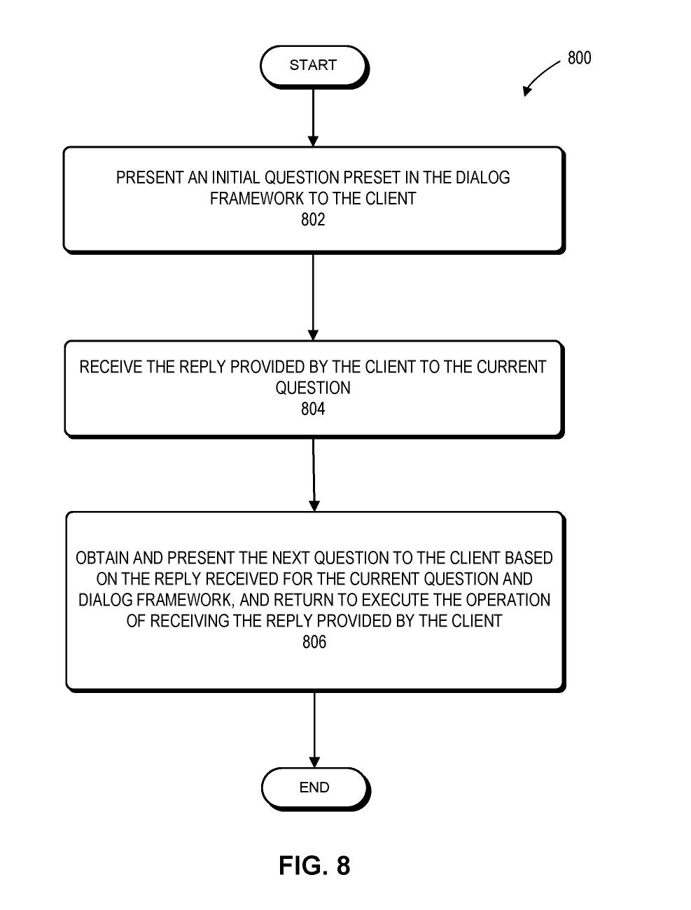

FIG. 8 presents a flowchart 800 illustrating sub-operations of operation 206 for presenting questions so that the next question is related to the content of a reply to a previously presented question, in accordance with an embodiment of the present invention. In some embodiments, using the second questioning method, sending the questions formulated in the dialog framework one by one to the client based on the dialog framework preset for the specific topic, and receiving the reply provided by the client to at least one question, includes the following operations: 1) present an initial question preset in the dialog framework to the client (operation 802); 2) receive the reply provided by the client to the current question (operation 804); and 3) obtain and present the next question to the client based on the reply received for the current question and the dialog framework, and the system may return to execute the operation of receiving the reply provided by the client (operation 806).

1) The system may present an initial question preset in the dialog framework to the client (operation 802).

In an implementation with the second questioning method, the system needs to first formulate for the dialog framework the initial question presented to the client. In contrast, to use the first questioning method, the system can present to the client all the questions in the dialog framework in random order. That is, the order in which the system presents the questions when using the first questioning method is not restricted, and therefore there is no need to set an initial question for the dialog framework of the first questioning method.

2) The system may receive the reply provided by the client to the current question (operation 804).

3) The system may obtain and present the next question to the client based on the reply received for the current question and the dialog framework, and the system may return to execute the operation of receiving the reply provided by the client (operation 806). The system may continue to repeat the process of presenting additional questions to the client based on the reply to the previous question (or questions).

When using the second questioning method, when the client provides a reply to a question, the system may determine the next question formulated in the dialog framework to present to the client based on the specific contents of the reply to the question. For example, the presented question can be: “what is your gender?” The client may respond with a reply which is: “male.” The next question will be the corresponding question formulated in the dialog framework relevant to males. This shows that, compared with the first questioning method, the second questioning method is more intelligent, as the system can present questions intelligently to the client through the preset dialog framework. The system can thereby provide a better user experience to the information provider, and the contents of an information collection package that the system generates through the second questioning method is more accurate and useful.

The system may subsequently create a record corresponding at least one of the questions and key information in the reply to the question to generate an information collection package for the specific topic (operation 208).

The replies to the questions may include at least all the answers from the information provider responding to the questions. The replies to the questions may include other information not relevant to the questions, various redundant information, and nonstandard dialog information, such as spoken language. Therefore, the system may need to eliminate the useless information from the replies to the questions and extract useful and key information from the replies. The key information in the replies to the questions refers to the dialogue content that is truly of interest to the information receiving party.

Corresponding at Least One Question and Key Information from a Reply

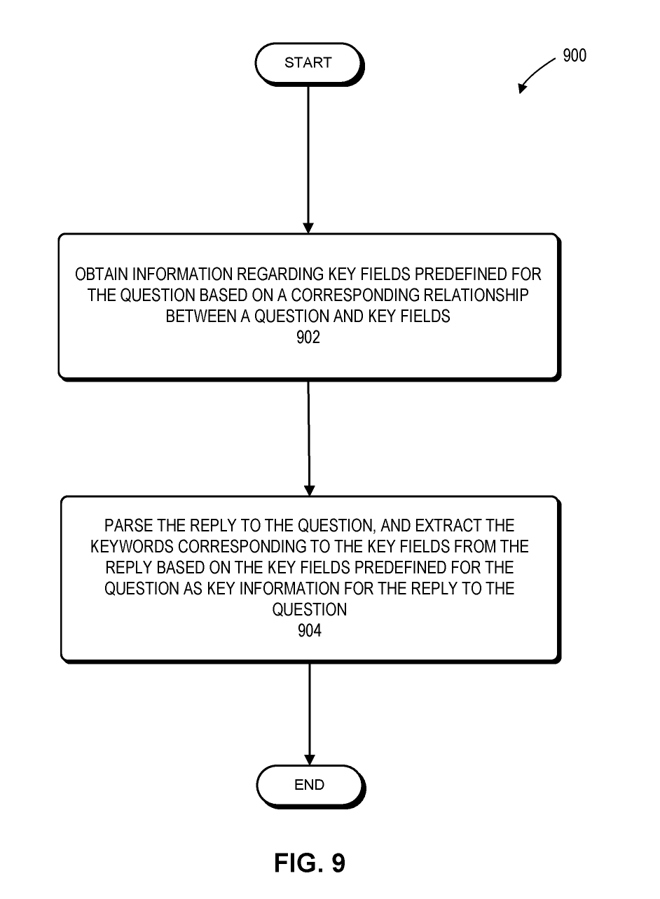

FIG. 9 presents a flowchart 900 illustrating sub-operations of operation 208 to correspond at least one question and key information from a reply, in accordance with an embodiment of the present invention. In some embodiments, the key information in the replies to the questions includes the corresponding keywords of key fields predefined for the questions in the replies to the questions. The key fields predefined for the questions may be indicated by the keywords included in the questions. For example, the question may be “What is the product specification that you need?” The keywords are “product specification.” The key information in the replies to the questions are indicated by the keywords of the reply corresponding to the key fields. For example, if the client's reply to the above question is “I want XL model,” the keyword in the reply is “XL.”

In some embodiments, the system may extract key information from a reply to a question by performing the following operations: 1) obtain information regarding key fields predefined for the question based on a corresponding relationship between (e.g., a pre-stored) question and key fields (operation 902); 2) parse the reply to the question, and extract the keywords corresponding to the key fields from the reply based on the key fields predefined for the question as key information for the reply to the question (operation 904).

1) The system may obtain information regarding key fields predefined for the question based on a corresponding relationship between (e.g., the pre-stored) question and key fields (operation 902).

As the corresponding relationship between questions and key fields includes the corresponding relationship between each question and the key field therein in the dialog framework, the information receiving party should preset the key fields of each question in the dialog framework in order for the system to extract key information from the replies to the questions.

2) The system may parse the reply to the question, and extract the keywords corresponding to the key fields from the reply based on the key fields predefined for the question as key information for the reply to the question (operation 904).

After the system obtains information regarding the key fields of a question, the system can extract corresponding keywords of the key fields, e.g., the key information in the replies, from the replies to the questions using various common semantic analysis methods.

The information collection package may include each question presented to the client and the key information in the reply to each question. In some embodiments, the information collection package includes a preset information collection report template. The information collection report template in an embodiment refers to a question report template preset for a specific topic by the information receiving party associated with the specific topic. For example, the information collection report template may be a form template. All types of information which the information receiving party associated with the specific topic may be seeking can be collected with the information collection report template.

The system may record a question and the key information from a reply corresponding to the question to form an information package directed to the specific topic. This may include the system performing a method that includes using the key information of each reply to populate a preset location (e.g., a data entry field located at the location) of the information collection report template.

### Populating Information Collection Report Template to Generate Information Collection Package

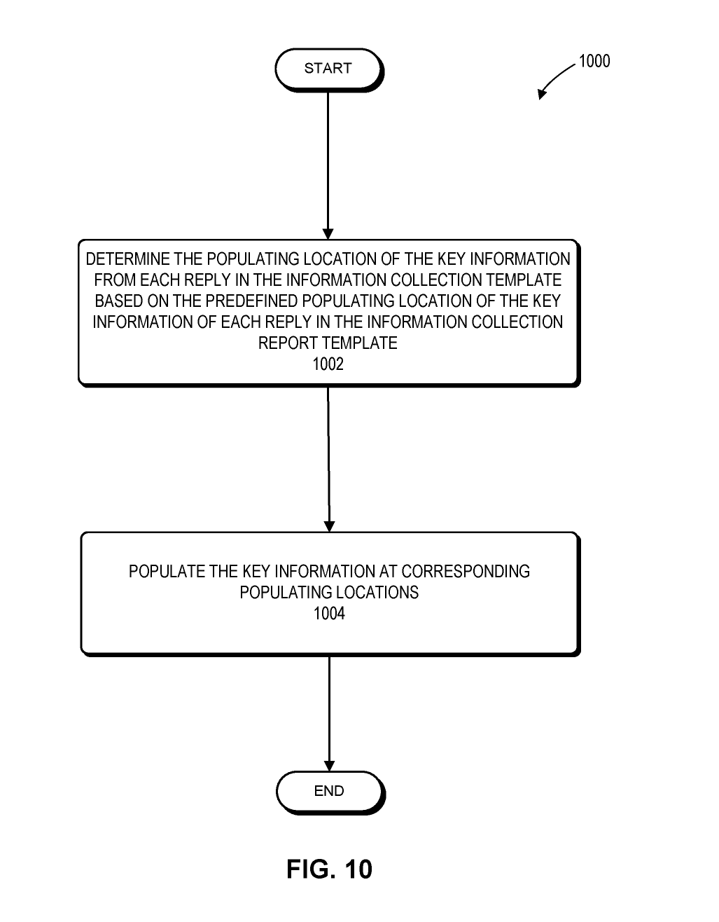

FIG. 10 presents a flowchart 1000 illustrating sub-operations of operation 208 to populate preset locations of an information collection report template, in accordance with an embodiment of the present invention. Specifically, using the key information of each reply to populate preset locations of the information collection report template may include performing the following operations: 1) determine the populating location of the key information from each reply in the information collection template based on the predefined populating location of the key information of each reply in the information collection report template (operation 1002); and 2) populate the key information at corresponding populating locations (operation 1004).

Through operations 202 to 208, the client may request a dialog based on a specific topic in an question and answer instant messaging method based on a dialog framework preset for the specific topic, to provide the client with a real time dialog service based on the specific topic. The system may also generate an information collection package directed at the specific topic based on the contents of the dialog.

In some implementations, based on specific application requirements, an information collection package directed to a specific topic generated based on dialog contents can be stored in different formats such as text format and database format.

Regarding the information collection package directed at specific topics formed based on dialog information, the information receiving party can actively request for the information collection package. Alternatively, the system can automatically send the information collection package to the information receiving party after generating the information collection package. In actual application, the system may select one of the two methods based on specific application requirements. If the system automatically sends the information collection package to the information receiving party after generating the information collection package, then the system may also perform the following operations:

The system may send the information collection package to the information receiving party associated with the specific topic (operation 312). After the system generates the information collection package of the specific topic through operations 202 to 208, the system may automatically send the information collection package to the information receiving party for review.

### Exemplary Apparatus for Collecting Information Based on a Specific Topic

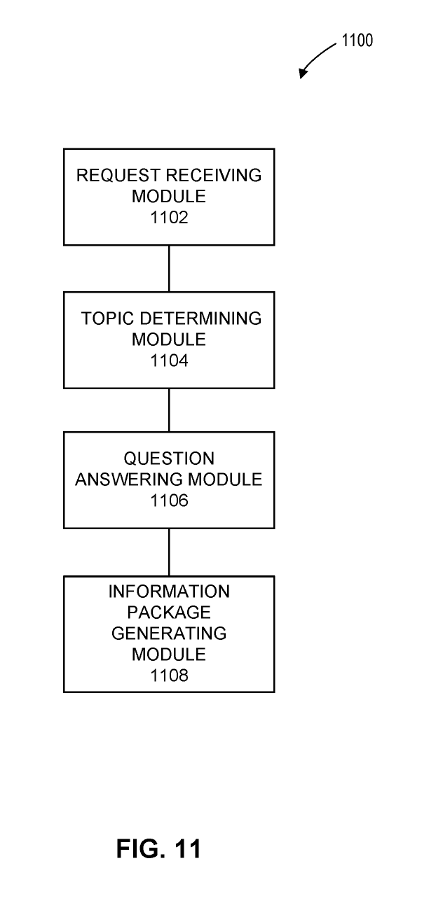

FIG. 11 is a schematic diagram illustrating an exemplary apparatus 1100 for collecting information based on a specific topic, in accordance with an embodiment of the present invention. An apparatus for collecting information based on a specific topic may include a request receiving module 1102, a topic determining module 1104, a question answering module 1106, and an information package generating module 1108.

Request receiving module 1102 may receive the dialog request sent by the client. Topic determining module 1104 may determine the specific topic corresponding to the dialog request based on keywords included in the dialog request.

Question answering module 1106 may send questions formulated in a dialog framework one by one to the client based on a preset dialog framework for the specific topic, and receive a reply to at least one question provided by the client.

Information package generating module 1108 may create a record corresponding key information from at least one question and the reply to the question to generate an information collection package for a specific topic.

The key information in the reply to the question includes keywords of the reply corresponding to predefined key fields of the question.

The information package generating module 1108 can also include:

a key information generating submodule to generate the key information in the reply to the question;

the key information generating submodule may include:

an obtaining submodule to obtain information regarding predefined key fields for the question based on the corresponding relationship between a pre-stored question and key fields;

a parsing submodule to parse the reply to the question, and, based on predefined key fields for the question, extract from the reply the keywords corresponding to the key fields as key information for the reply to the question.

### Exemplary Question Answering Modules

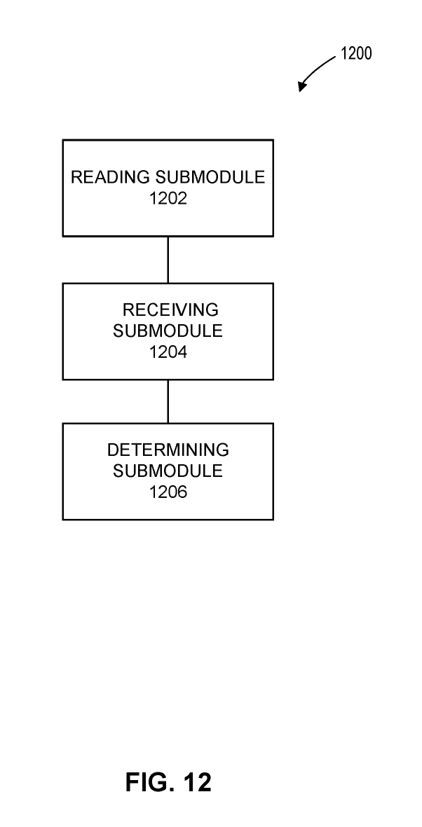

FIG. 12 is a schematic diagram illustrating an exemplary question answering module 1200, in accordance with an embodiment of the present invention. FIG. 12 illustrates an example of question answering module 1106 from FIG. 11. Question answering module 1200 may include a reading submodule 1202, a receiving submodule 1204, and a determining submodule 1206.

Reading submodule 1202 may read the question formulated in the dialog framework in traversal mode, and present the question to the client. Receiving submodule 1204 may receive a reply provided by the client to the question. Determining submodule 1206 may determine whether there are any questions that have not been presented to the client. If there is a question that has not been presented to the client, then the system may repeat the operations of reading the question formulated in the dialog framework in traversal mode, and presenting the next question to the client.

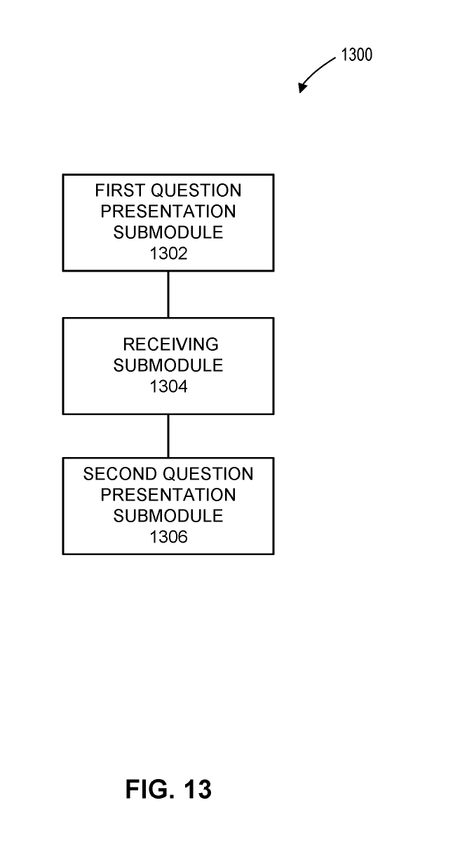

FIG. 13 is a schematic diagram illustrating another exemplary question answering module 1300, in accordance with an embodiment of the present invention. FIG. 13 illustrates another example of question answering module 1106 from FIG. 11. Question answering module 1300 may include a first question presentation submodule 1302, a receiving submodule 1304, and a second question presentation submodule 1306.

First question presentation submodule 1302 may present an initial question pre-formulated in the dialog framework to the client. Receiving submodule 1304 may receive a reply to the question provided by the client. Second question presentation submodule 1306 may obtain and present the next question to the client on the basis of a received reply to a current question and the dialog framework, and receive a reply provided by the client to the next question.

### Exemplary Information Collection Apparatus

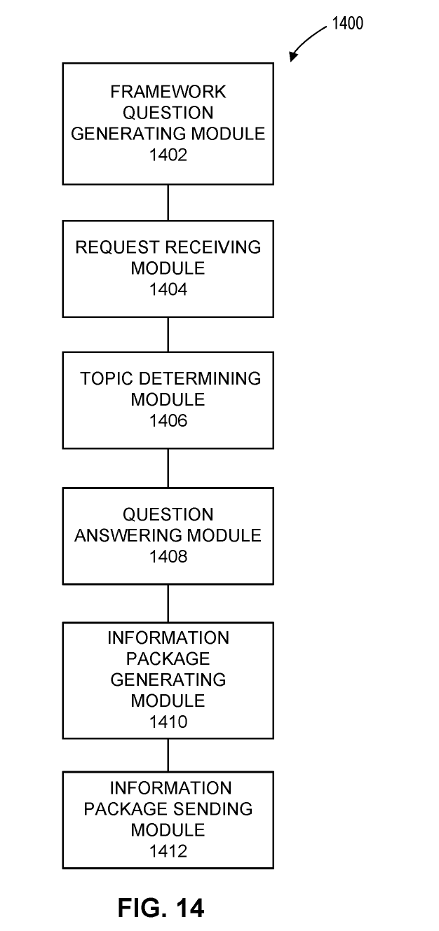

FIG. 14 is a schematic diagram illustrating an exemplary information collection apparatus 1400 for a specific topic, in accordance with an embodiment of the present invention. The apparatus may include a framework question generating module 1402, a request receiving module 1404, a topic determining module 1406, a question answering module 1408, an information package generating module 1410, and an information package sending module 1412.

Framework question generating module 1402 may generate the questions formulated in the dialog framework.

Optionally, the framework question generating module 1402 may include a first framework question generating submodule.

The system may use the first framework question generating submodule to generate questions formulated in the dialog framework based on a historical dialog record relevant to a specific topic.

The first framework question generating submodule may also include:

an obtaining submodule to obtain the historical dialog record relevant to the specific topic;

an extracting submodule to extract required elements for constructing the dialog framework from the historical dialog framework using machine learning;

a generating submodule to generate the questions formulated in the dialog framework based on the required elements for constructing the dialog framework;

Optionally, the framework question generating module 1402 may include a second framework question generating submodule.

The system may use the second framework question generating submodule to generate questions formulated in the dialog framework based on the original dialog framework preset for the specific topic. In some implementations, the quantity of the original dialog frameworks is at least two.

The second framework question generating submodule may include:

an obtaining submodule to obtain original dialog frameworks;

an extracting submodule to extract common questions from each original dialog framework among multiple original dialog frameworks; and

a setting submodule to use the common questions as questions formulated in the dialog framework based on a specific topic.

Optionally, the framework question generating module 1402 may include a third framework question generating submodule.

The system may use the third framework question generating submodule to generate questions formulated in the dialog framework based on the information collection question template preset for the specific topic.

The third framework question generating submodule may include:

an obtaining submodule to obtain the original dialog framework;

a parsing submodule to parse a preset information collection question template, and obtain the questions included in the information collection question template; and

a setting submodule to use the questions included in the information collection question template as the questions formulated in the dialog framework.

Modules 1404-1410 are equivalent to their respective counterparts described with respect to FIG. 11.

Optionally, the device also may include an information package sending module 1412 to send the information collection package to the information receiving party associated with the specific topic.

### Exemplary Electronic Equipment

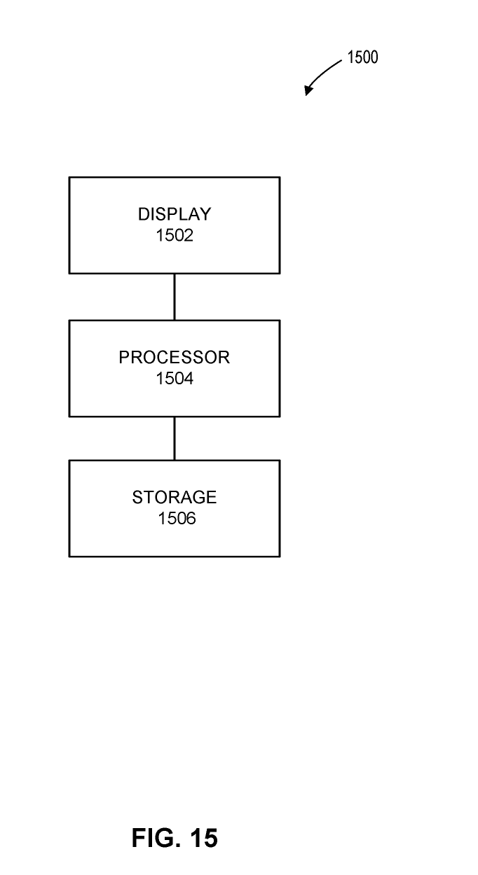

FIG. 15 presents a block diagram illustrating an exemplary electronic equipment 1500, in accordance with an embodiment of the present application. Electronic equipment 1500 may include a display 1502, a processor 1504, and a storage 1506. Processor 1504 may determine a specific topic corresponding to a dialog request based on keywords received from the dialog request sent by a client. Processor 1504 may send to the client one by one the questions formulated in the dialog framework based on the preset dialog framework of the specific topic, and receive a reply provided by the client regarding at least one question. Storage 1506 may be configured to store the information collection package of the specific topic. The system may generate the information collection package based on a record corresponding key information between at least one question and the reply to the question.

This disclosure describes an information collection method based on a specific topic, an apparatus, a system, and an electronic equipment. The system determines a specific topic corresponding to a dialog request based on received keywords included in the dialog request sent by a client. Then, the system may send one by one the questions formulated in a dialog framework based on a dialog framework preset for the specific topic and receive a reply provided by the client regarding at least one question. Finally, the system may record a corresponding question and the keywords in the reply to the question and generate an information collection package directed at the specific topic. The system may provide a dialog service to the client using a question and answer technique in accordance with the dialog framework preset for the specific topic. This allows the system to provide a real-time dialog service with respect to the specific topic to the client to improve the information collection success rate and improve the user experience even when an information receiving party is offline.

### Exemplary Process for Instant Messaging-Based Inquiry

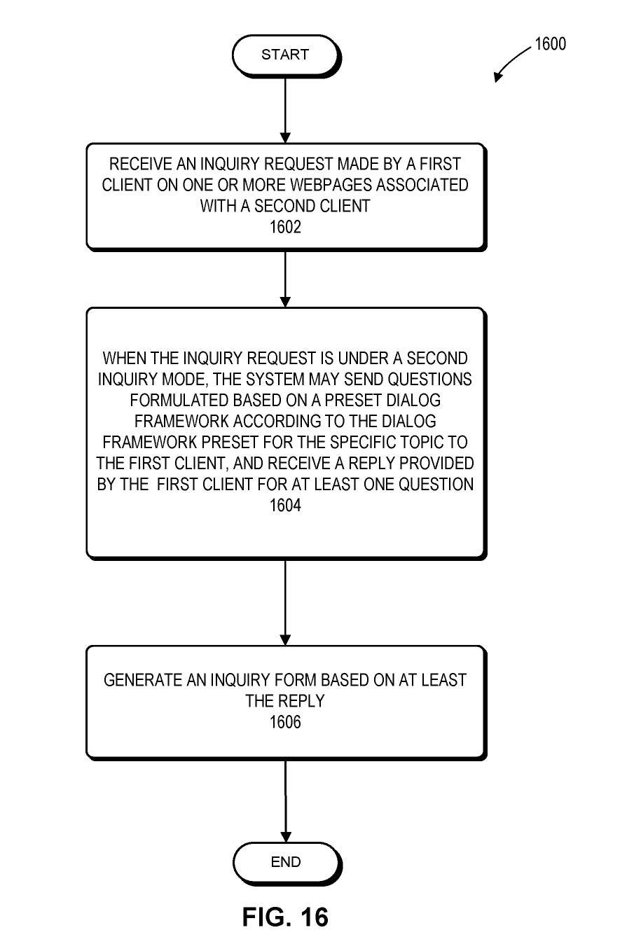

FIG. 16 presents a flowchart illustrating an exemplary process 1600 for instant messaging-based inquiry, in accordance with an embodiment of the present invention. Embodiments of the present invention may also include an instant messaging-based inquiry method that the system can use to facilitate information exchange between a first client and a second client on an electronic business platform (e.g., e-commerce website).

The operations of the method may include: 1) receive an inquiry request made by a first client on one or more webpages associated with a second client (operation 1602); 2) when the inquiry request is under a second inquiry mode, send questions formulated based on a preset dialog framework according to the dialog framework preset for the specific topic to the first client, and receive a reply provided by the first client for at least one question (operation 1604); and 3) generating an inquiry form based on at least the reply (operation 1606). These operations are discussed in greater detail below.

1) During operation, the system may receive an inquiry request made by a first client on one or more webpages associated with a second client (operation 1602).

The instant messaging-based inquiry method is one of the application scenarios for information collection based on a specific topic. The first client is a client associated with an inquiring party, and the second client is a client associated with an inquiry receiving party. An e-commerce platform is a trading platform providing inquiry services. The inquiry receiving party at the second client can provide available products on the e-commerce platform, and the second client is associated with a product details webpage for the available products.

When the inquiring party on the first client finds available products provided by the inquiry receiving party on the e-commerce platform, the inquiring party can inquire as to the products of interest using the methods described herein. The system (e.g., e-commerce platform) may generate an inquiry form based on questions and replies during the inquiring process. The inquiring party can use online instant messaging, and the inquiry receiving party can provide real-time inquiry services to the inquiring party even when the inquiry receiving party is offline.

### Exemplary Webpages Under a First Inquiry Mode/Second Inquiry Mode

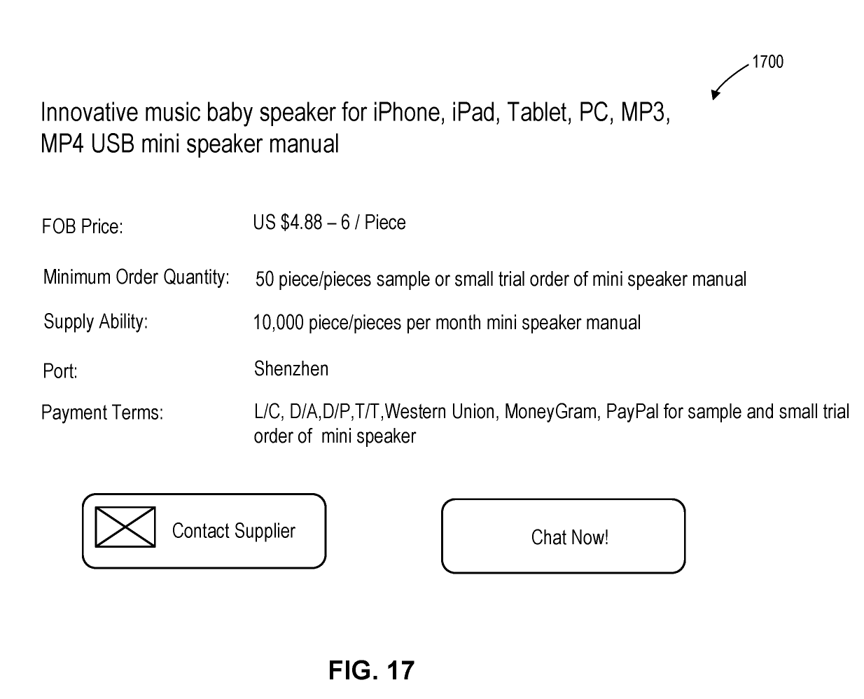

FIG. 17 is a diagram illustrating an exemplary webpage 1700 associated with a second client for an instant messaging-based inquiry method under a first inquiry mode, in accordance with an embodiment of the present invention. The inquiry requests described herein may indicate at least one of a first inquiry mode and a second inquiry mode. Under the first inquiry mode, a user associated with the second client (e.g., the inquiry receiving party) can conduct instant communication with a user associated with the first client (e.g., the inquiring party). FIG. 17 shows the details of a specific product, including basic information such as name, price, and specification. The “Chat Now!” button corresponds to the first inquiry mode. The system displays the button when the inquiry receiving party is online. The inquiring party may enter the first inquiry mode in which the inquiring party can conduct real-time inquiry communication with the inquiry receiving party by clicking the “Chat Now!” button.

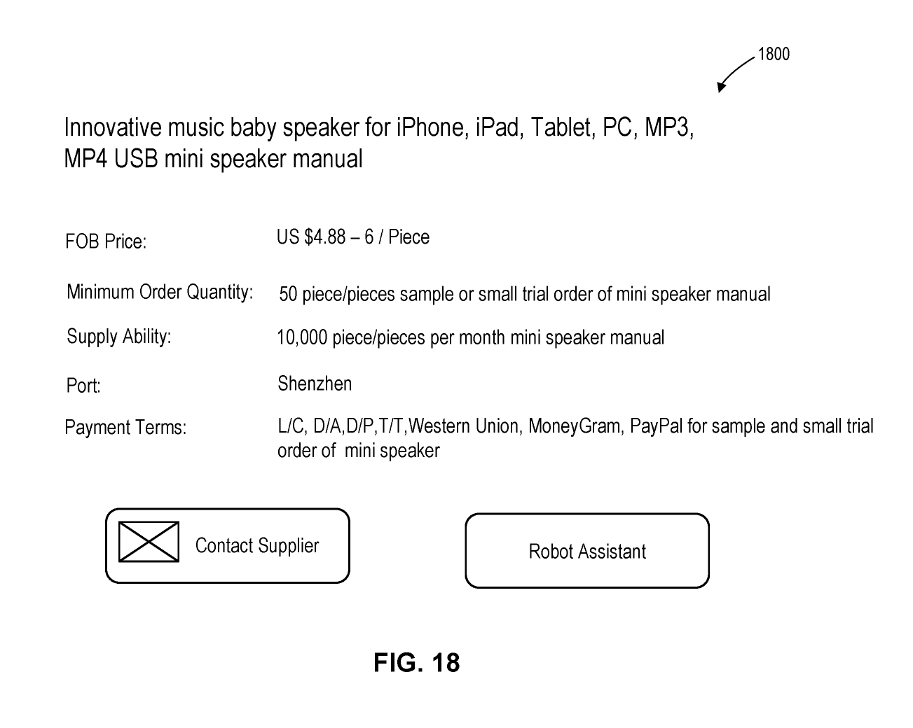

FIG. 18 is a diagram illustrating an exemplary webpage 1800 associated with a second client for an instant messaging-based inquiry method under a second inquiry mode, in accordance with an embodiment of the present invention. Under the second inquiry mode, a user associated with the second client is not directly conducting instant communication with a user associated with the first client. The inquiry receiving party provides real-time inquiry services to the inquiring party using an inquiry robot. The “Robot Assistant” button corresponds to the second inquiry mode. The system displays the button when the inquiry receiving party is offline. By clicking the “Robot Assistant” button, the inquiring party will enter the second inquiry mode in which the inquiry robot can conduct real-time inquiry communications with the inquiring party.

2) When the inquiry request is under a second inquiry mode, the system may send questions formulated based on a preset dialog framework according to the dialog framework preset for the specific topic to the first client, and receive a reply provided by the first client for at least one question (operation 1604).

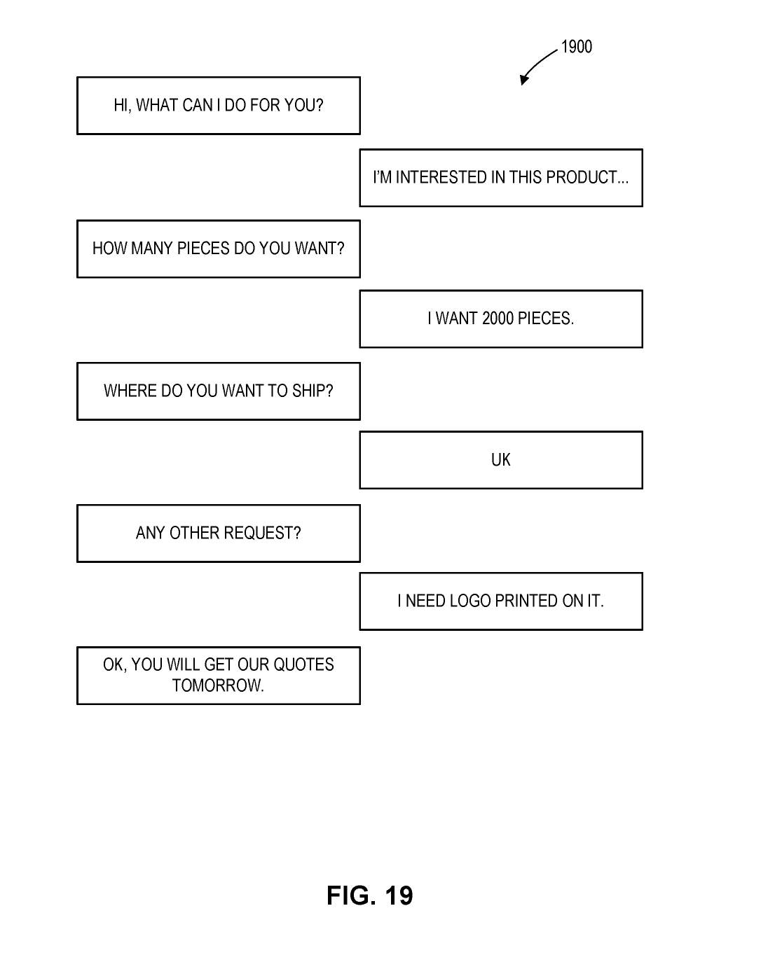

FIG. 19 is a diagram illustrating an exemplary question page 1900 of an instant messaging-based inquiry method for a first client under a second inquiry mode, in accordance with an embodiment of the present invention. FIG. 19 lists part of the dialog between an inquiry robot and an inquiring party in which the inquiry robot presents questions to the inquiring party that are based on a preset dialog framework. In some embodiments, the preset dialog framework is equivalent to the preset dialog framework of an information collection method based on a specific topic.

3) The system may generate an inquiry form based on at least the reply (operation 1606).

### Inquiry Form Generated Using an Instant Messaging-Based Inquiry Method

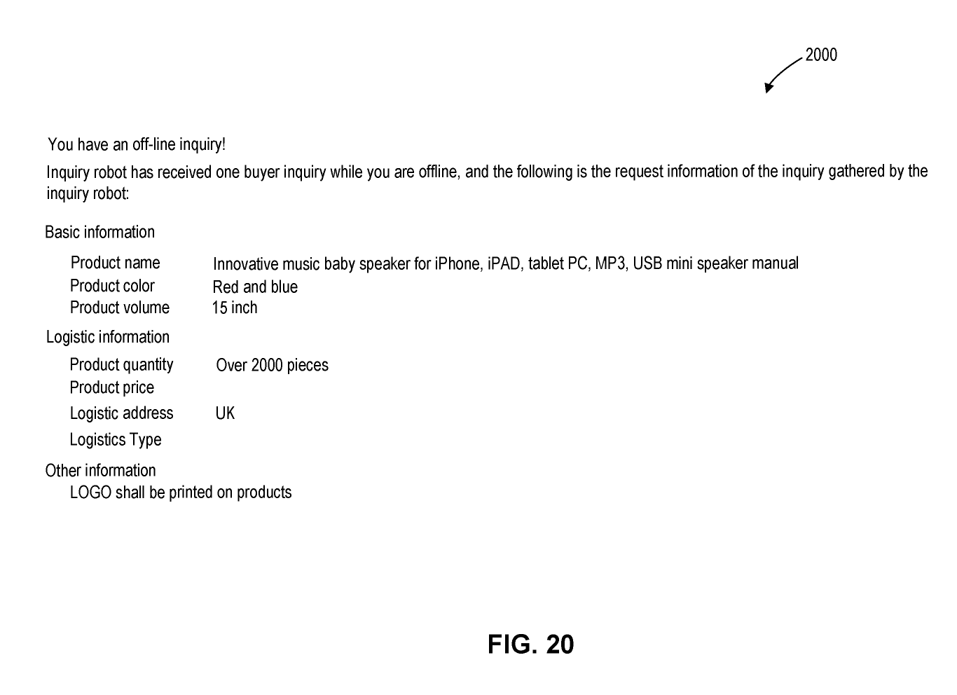

FIG. 20 is a diagram illustrating an exemplary inquiry form 2000 generated using an instant messaging-based inquiry method, in accordance with an embodiment of the present invention. The system may generate an inquiry form based on dialog between an inquiry robot and an inquiring party. In some embodiments, the inquiry form is mainly divided into two parts. One part is the basic information of the products and the other part is the logistics information for the products. In practical application, it is feasible to design different types of inquiry forms based on specific requirements.

In some embodiments, an e-commerce platform is configured to prioritize sending the inquiry form to a user associated with the second client within a first time period after generating the inquiry form. The first time period is related to the time zones in which the user associated with the first client and the user associated with the second client reside. Generally, when differences between the time zones in which the user associated with the first client resides and the time zone in which the user associated with the second client resides is relatively large, the first time period is a relatively long time interval. Otherwise, the first time period is a relatively short time interval.

Configuring the e-commerce platform to prioritize sending the inquiry form to a user associated with the second client within the first time period after the inquiry form is generated can enable the user associated with the second client to obtain the inquiring party's product requirements within a reasonable time period.

In some embodiments, the e-commerce platform is also configured to prioritize sending the inquiry form to users of other clients associated with the topic of the inquiry form after the first time period after the inquiry form is generated.

For example, other vendors selling the products that are the subject of the inquiry can be deemed as the users of other clients associated with the topic of the inquiry form. Configuring the e-commerce platform to prioritize sending the inquiry form to users of other clients associated with the topic of the inquiry form after the first time period after the inquiry form is generated can provide the users of the other clients an opportunity to obtain the inquiring party's product requirements. Generally, users of other clients associated with the topic of the inquiry form obtain the inquiring party's product requirements after the user associated with the second client has obtained the inquiring party's product requirements.

### Exemplary Instant Messaging-Based Inquiry Apparatus

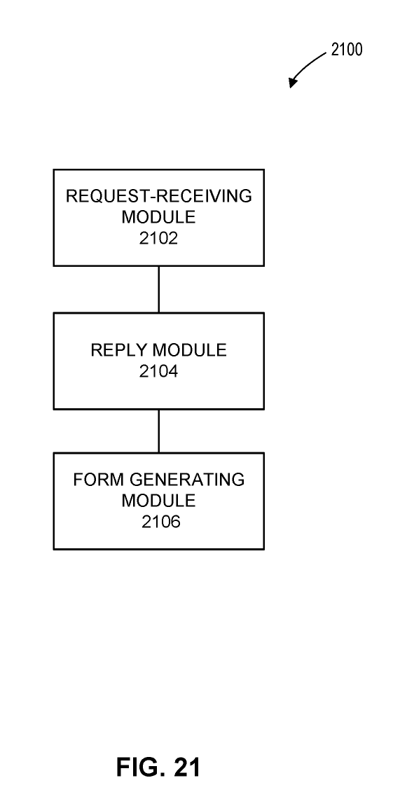

FIG. 21 presents a block diagram illustrating an exemplary instant messaging-based inquiry apparatus 2100, in accordance with an embodiment of the present invention. Instant messaging-based inquiry apparatus 2100 can facilitate information exchange between a first client and a second client on an e-commerce platform. The apparatus may include a request-receiving module 2102, a reply module 2104, and a form generating module 2106.

Request-receiving module 2102 may receive an inquiry request initiated by a first client on a webpage associated with a second client. The inquiry request may indicate at least one of a first inquiry mode and a second inquiry mode. Under the first inquiry mode, the user associated with the second client may conduct instant communication with the user associated with the first client. Under the second inquiry mode, the user associated with the second client is unable to conduct instant communication with the user associated with the first client. Instead, an inquiry robot may provide real-time inquiry services.

When the inquiry request is under the second inquiry mode, reply module 2104 may send a question formulated based on a preset dialog framework to the first client according to the dialog framework preset for the specific topic, and receive a reply provided by the client to at least one question.

Form generating module 2106 may generate an inquiry form based at least on the reply.

In addition, this disclosure also describes electronic equipment that includes a display, a processor, and a storage. The storage may be configured to store software for an instant messaging-based inquiry device. When the processor operates the instant messaging-based inquiry device, the device may perform operations. These operations include receiving an inquiry request initiated by a first client on a webpage associated with a second client, the inquiry request indicating at least one of a first inquiry mode and a second inquiry mode.

Under a first inquiry mode, the user associated with the second client may conduct instant communications with the user associated with the first client. Under a second inquiry mode, the user associated with the second client does not participate in instant communications with the user associated with the first client. When the inquiry request is under the second inquiry mode, the system may send questions formulated based on a preset dialog framework to the first client according to the dialog framework preset for a specific topic, and receive a reply provided by the client to at least one question. The system may generate an inquiry form based on at least the reply.

The instant messaging-based inquiry method, apparatus and electronic apparatus described in this disclosure can receive an inquiry request initiated by a first client on a webpage associated with a second client, and the inquiry request may include at least a first inquiry mode and a second inquiry mode. Under a second inquiry mode, the user associated with a second client does not participate in instant communications with the user associated with a first client. When an inquiry request is made under a second inquiry mode, the system (e.g., e-commerce platform) may send questions formulated based on a preset dialog framework to a first client according to the dialog framework preset for a specific topic, and receive a reply provided by the client to at least one question. The system may generate an inquiry form based on at least the reply. Since the system can provide an inquiry service to the user associated with the first client in a question and answer manner based on a preset dialog framework, the system can still provide an inquiry service to the user associated with the first client even when the user associated with the second client is offline. This increases the success rate of the inquiry and ensures a better user experience.

### Exemplary Server

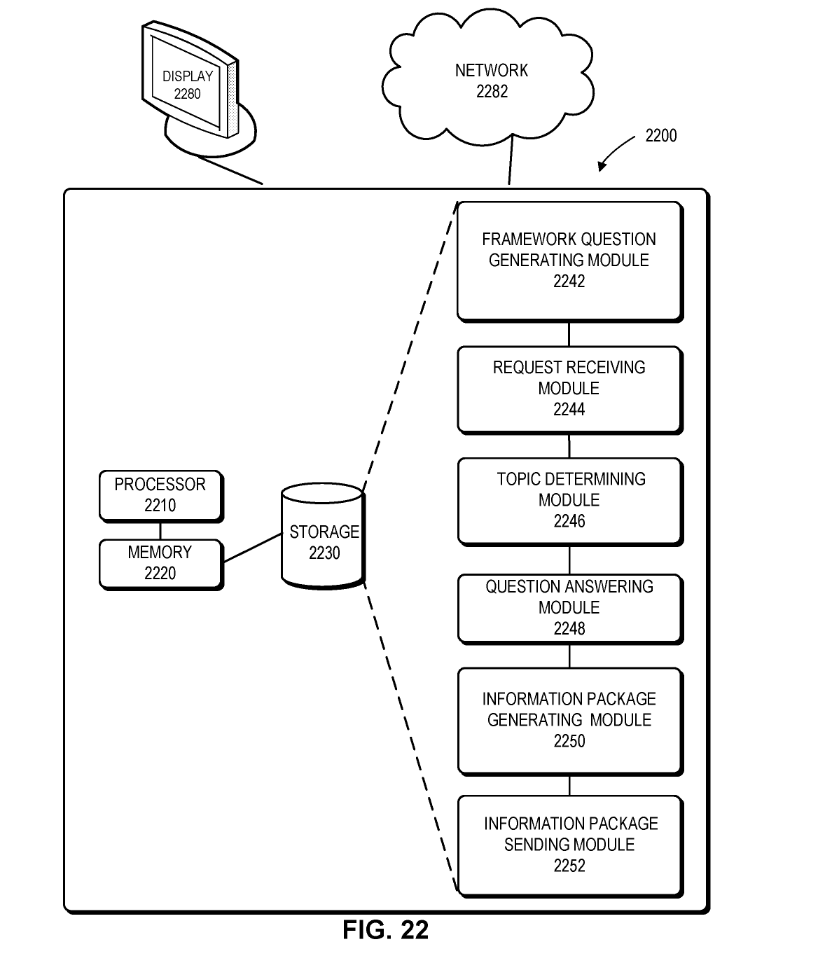

FIG. 22 presents a block diagram illustrating an exemplary server 2200 in a system for information collection based on a specific topic, in accordance with an embodiment of the present application. Server 2200 includes a processor 2210, a memory 2220, and a storage device 2230. Storage 2230 typically stores instructions that can be loaded into memory 2220 and executed by processor 2210 to perform the methods described above. In one embodiment, the instructions in storage 2230 can implement a framework question generating module 2242, a request receiving module 2244, a topic determining module 2246, a question answering module 2248, an information package generating module 2250, and an information package sending module 2252, which can communicate with each other through various means.

In some embodiments, modules 2242-2252 can be partially or entirely implemented in hardware and can be part of processor 2210. Further, in some embodiments, the server may not include a separate processor and memory. Instead, in addition to performing their specific tasks, modules 2242-2252, either separately or in concert, may be part of special-purpose computation engines.

Storage 2230 stores programs to be executed by processor 2210. Specifically, storage 2230 stores a program that implements a server (e.g., application) for information collection based on a specific topic. During operation, the application program can be loaded from storage 2230 into memory 2220 and executed by processor 2210. As a result, server 2200 can perform the functions described above. Server 2200 can further include a display 2280, and can be coupled via one or more network interfaces to a network 2282.

Framework question generating module 2242 may generate the questions formulated in a dialog framework. Request receiving module 2244 may receive a dialog request sent by a client. Topic determining module 2246 may determine a specific topic corresponding to the dialog request based on keywords included in the dialog request. Question answering module 2248 may send questions formulated in a dialog framework one by one to the client based on a preset dialog framework for the specific topic, and receive a reply to at least one question provided by the client. Information package generating module 2250 may create a record corresponding key information from at least one question and the reply to the question to generate an information collection package for a specific topic. Information package sending module 2252 may send the information collection package to the information receiving party associated with the specific topic.

Embodiments of the present invention may be implemented on various universal or dedicated computer system environments or configurations. For example, such computer systems may include personal computers, server computers, handheld or portable devices, tablet-type devices, multiprocessor systems, microprocessor-based systems, set-top boxes, programmable electronic consumption devices, network PCs, minicomputers, mainframe computers, distributed computing environments including any of the above systems or devices, and the like.

Embodiments of the present invention may be described within the general context of computer-executable instructions executed by a computer, such as a program module. Generally, the program module includes a routine, a program, an object, an assembly, a data structure and the like for implementing particular tasks or achieving particular abstract data types. Embodiments of the present invention may also be implemented in distributed computing environments, in which tasks are performed by remote processing devices connected via a communication network. In the distributed computing environments, program modules may be located in local and remote computer storage media that may include a storage device.

The data structures and computer instructions described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

What is claimed is:

1. A computer-implemented method to collect information for a specific topic, comprising:
receiving a dialog request sent by a client;
determining a specific topic corresponding to the dialog request based on at least one keyword included in the dialog request;
sending questions in a predetermined order to the client;
receiving a reply provided by the client to at least one question; and
creating a record corresponding to at least one of the questions and key information in the reply, wherein the record is used to generate an information collection package for the specific topic.

2. The method of claim 1, wherein key information in the reply to the question includes keywords of the reply corresponding to predefined key fields of the question.

3. The method of claim 1, further comprising:
determining key fields predefined for a question based on a corresponding relationship between the question and key fields;
parsing the reply to the question; and
extracting keywords corresponding to the key fields from the reply based on the key fields predefined for the question as key information for the reply to the question.

4. The method of claim 1, wherein the information collection package includes a preset information collection report template.

5. The method of claim 4, further comprising creating a record corresponding at least one of the questions and key information in the reply to the question to generate an information collection package for the specific topic, which involves:
using the key information of the reply to the question to populate a preset location of an information collection report template.

6. The method of claim 1, wherein sending questions in a predetermined order to the client and receiving a reply provided by the client to at least one question further comprises:
reading a question formulated in a dialog framework in traversal mode;
presenting the question to the client;
receiving a reply provided by the client to the question;
determining whether there is any question that has not been presented to the client; and
in response to determining that there is a question that has not been presented to the client, reading a next question formulated in the dialog framework to present the next question to the client.

7. The method of claim 1, wherein sending questions in a predetermined order to the client and receiving a reply provided by the client to at least one question further comprises:
presenting a current question preset in a dialog framework to the client;
receiving a reply provided by the client to the current question; and
obtaining and presenting a next question to the client based on the reply received for the current question and the dialog framework; and
receiving a reply provided by the client for the next question.

8. The method of claim 1, wherein the questions pre-formulated for the dialog framework are customizable.

9. The method of claim 1, further comprising:
generating questions formulated in the dialog framework based on a historical dialog record relevant to the specific topic.

10. The method of claim 9, wherein generating the questions formulated in the dialog framework further comprises:
obtaining a historical dialog record relevant to the specific topic;
extracting required elements for constructing the dialog framework from the historical dialog record with machine learning; and
generating the questions formulated in the dialog framework based on required elements for constructing the dialog framework.

11. The method of claim 1, wherein the questions formulated in the dialog framework are generated based on one or more original dialog frameworks preset for the specific topic.

12. The method of claim 11, wherein the questions formulated in the dialog framework are generated by performing operations comprising:
obtaining multiple original dialog frameworks;
extracting common questions from among the multiple original dialog frameworks; and
using the common questions as the questions formulated in the dialog framework for the specific topic.

13. The method of claim 1, wherein the questions formulated in the dialog framework are generated based on the information collection question template preset for the specific topic.

14. The method of claim 13, wherein the questions formulated in the dialog framework are generated by performing operations comprising:
parsing the preset information collection question template;
obtaining the questions included in the information collection question template; and
using the questions in the information collection question template as the questions formulated in the dialog framework.

15. The method of claim 1, further comprising:
sending the information collection package to an information receiving party associated with the specific topic.

16. A computing system comprising:
one or more processors;
a memory; and
a non-transitory computer-readable medium coupled to the one or more processors storing instructions stored that, when executed by the one or more processors, cause the computing system to perform a method to collect information for a specific topic, the method comprising:
receiving a dialog request sent by a client;
determining a specific topic corresponding to the dialog request based on keywords included in the dialog request;
sending questions formulated in a dialog framework to the client one by one according to the dialog framework preset for the specific topic;
receiving a reply provided by the client to at least one question; and
creating a corresponding record for at least one of the questions and key information in the reply to generate an information collection package for the specific topic.

17. A non-transitory computer-readable storage medium storing instructions that when executed by a computer cause the computer to perform a method to collect information for a specific topic, the method comprising:
receiving a dialog request sent by a client;
determining a specific topic corresponding to the dialog request based on keywords included in the dialog request;
sending questions formulated in a dialog framework to the client one by one according to the dialog framework preset for the specific topic;
receiving a reply provided by the client to at least one question; and
creating a corresponding record for at least one of the questions and key information in the reply to generate an information collection package for the specific topic.

18. A computer-implemented method for instant communication-based inquiry between a first client and a second client exchanging information on an online publication platform, comprising:
receiving an inquiry request made by a first client on a network-page associated with a second client, wherein the inquiry request includes at least a first inquiry mode and a second inquiry mode, wherein under the first inquiry mode, a user associated with the second client conducts instant communication with a user associated with the first client, and under the second inquiry mode, a user associated with the second client is not directly conducting instant communication with the user associated with the first client;
sending questions in a sequential order to the first client when the inquiry request is under the second inquiry mode;
receiving at least one reply provided by the first client for at least one question; and
generating an inquiry form based at least on the reply.

19. The method of claim 18, wherein the online publication platform is configured to send the inquiry form to the user associated with the second client within a first time period after generating the inquiry form, wherein the user associated with the second client publishes one or more items on the network-page.

20. The method of claim 18, wherein the online publication platform is configured to send the inquiry form to users of other clients after a first time period that the inquiry form is generated, wherein the users of other clients publish similar items as those published on the network-page.
